(19) United States
(12) Patent Application Publication
(10) Pub. No.: US 2010/0164432 A1
(43) Pub. Date: Jul. 1, 2010

(54) Method and device for recharging a headset

(75) Inventors: Joseph Yang, San Jose, CA (US); Scott Burr, Ben Lomond, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC.

(21) Appl. No.: 11/809,846

(22) Filed: Jun. 1, 2007

(51) Int. Cl. H02J 7/00; H02J 7/02

(52) U.S. Cl. 320/111; 320/107; 320/137

(57) ABSTRACT

A system for recharging a headset includes a base, a cradle connected to the base, and an electrical plug connected to the base, wherein the cradle is formed of resilient material which is deformable to accommodate headsets of different dimensions.

### FIELD OF INVENTION

The present invention relates generally to the field of headsets such as those used for telephone communication.

### BACKGROUND OF INVENTION

Headsets are often used for telephone communication and some headsets can be very light and portable. To aid portability some headsets are equipped with wireless capabilities, which can be enabled by the Bluetooth technology. In this way the headset communicates with a local transmitter-receiver by radio rather than through wires. Consequently the headset lacks a source of power from an AC source and therefore instead has rechargeable batteries.

In recent years battery technology has improved but nevertheless the rechargeable batteries must be recharged from an AC source after the headset has been used a significant time.

Improvements to systems for recharging a headset are of significant value and commercial interest.

Also, contemporary headsets have become very light and portable and users can be seen wearing a headset in the ear as they walk around. However, when the user removes a headset it is desirable to have a convenient place to store the headset, and such storage systems are sometimes termed docking systems. Improvements in such storage systems are desirable.

### SUMMARY OF THE INVENTION

A system for recharging a headset is taught which includes a base, a cradle connected to the base, and an electrical plug connected to the base, wherein the cradle is formed of resilient material which is deformable to accommodate headsets of different dimensions.

According to one aspect of the invention a user can use the device to support and recharge the headphone. Also, the user can disassemble the device to create simply a charger without the storage feature.

According to another aspect of the invention, the same system for recharging a headset can be used to store and recharge both a headset without a windscreen and the same headset with a windscreen.

### BRIEF DESCRIPTION OF THE DRAWINGS

FIG. 1 shows an embodiment of the present headset recharging system;

FIG. 2 shows the system of FIG. 1 partially disassembled;

FIG. 3 shows the system of FIG. 1 partially disassembled;

FIG. 4 shows a bottom view of the electrical charging system support member of FIG. 3;

FIG. 5 shows a front view of the electrical charging system support member of FIG. 3;

FIG. 6 shows the base and the cradle of FIG. 3 disassembled from each other;

FIG. 7 shows a front view of the base and the cradle of FIG. 3 assembled to each other;

FIG. 8 shows a side view of the base and the cradle of FIG. 3 assembled to each other;

FIG. 9 shows a front view of a headset;

FIG. 10 shows a side view of a headset with the ear hanger removed;

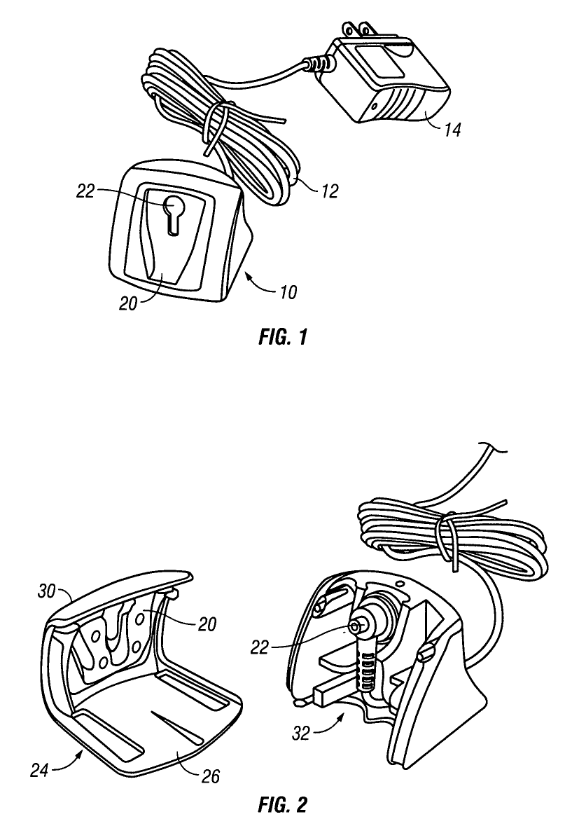

FIG. 1 shows the headset as used with an embodiment of the charging device;

FIG. 12 shows an isometric view of a headset;

FIG. 13 shows the headset of FIG. 12 as used with an embodiment of the charging device; and

FIGS. 14-19 show alternative embodiments of the headset charging system.

### DETAILED DESCRIPTION

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Turning now to FIGS. 1-3 an embodiment of the present invention for recharging a headset is illustrated. This embodiment includes a support 10, a cable 12 and a transformer 14, which can be plugged into a wall outlet. The support 10 includes a cradle 20 and an electrical plug 22, and the headset can be placed in the cradle so that a jack in the headset engages the plug 22 to charge the headset.

The support 10 includes a base 24 which has a generally flat surface 26 which can be placed on a desk and a headset support section 30 which is coupled to the base 24 at an angle so that face of the headset support section 30 is positioned at an angle of about 75 degrees from horizontal. The headset support section 30 has rounded edges and includes a rectangular cut out section in which is mounted the cradle 20. The base 24 is formed of a relatively rigid plastic whereas the cradle 20 is formed of a relatively resilient plastic so that the cradle 20 can deform to snugly grip a headset which located in the cradle 20.

The support 10 further includes an electrical charging system support member 32 which is formed of a material which is resilient. The electrical charging system support member 32 supports electrical plug 22 and part of cable 12.

Turning now to FIGS. 3-5 the embodiment is shown disassembled. The charging system support member 32 has a left side 40, right side 42, a bottom 44 and a front side 46 and back side 48. The charging system support member 32 is made of resilient material and includes two channels 50 and 52 formed one along each of the edges of its front side which can engage and grip the edged of the base 24 when the edges are pressed into the channels. The bottom 44 of the charging system support member 32 includes two ridges 54 and 56 which engage two slots 58 and 60 formed in the flat surface 26 of the base 24. The charging system support member 32 also includes a generally U-shaped channel 62 located near the top of the front side of the member 32 to accommodate and grip a button member 64 of the plug 22. The charging system support member 32 also includes a cable channel 66 which extends from the base of the U-shaped channel to the back side 48 of the charging system support member 32, and the cable channel 66 can accommodate and grip a section of the electrical cable 12.

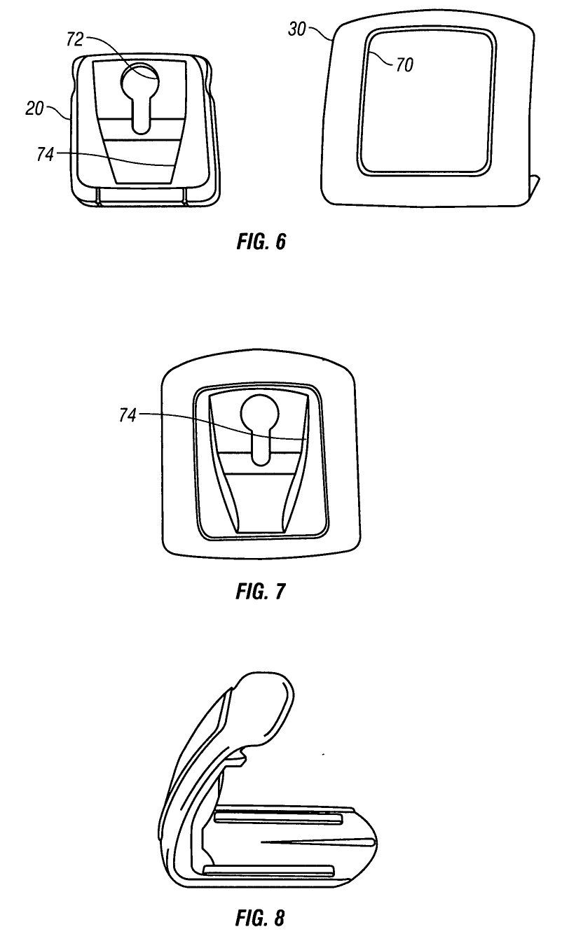

Turning now to FIGS. 6-8, the cradle 20 is shown removed from a cut out section 70 of the headset support section 30 (FIG. 6) and installed in the cut out section 60 (FIGS. 7-8) The cradle 20 includes a port 72 which is shaped to accommodate the plug 22 and a part of the cable 12. The cradle 20 is resilient and shaped with a generally V-shaped indentation 74 formed to match the shape of the lower part of a headset, and the cradle 20 can be press fitted into the cut out section 60 and remain engaged therewith when the user pushes a headset into the V-shaped indentation 74.

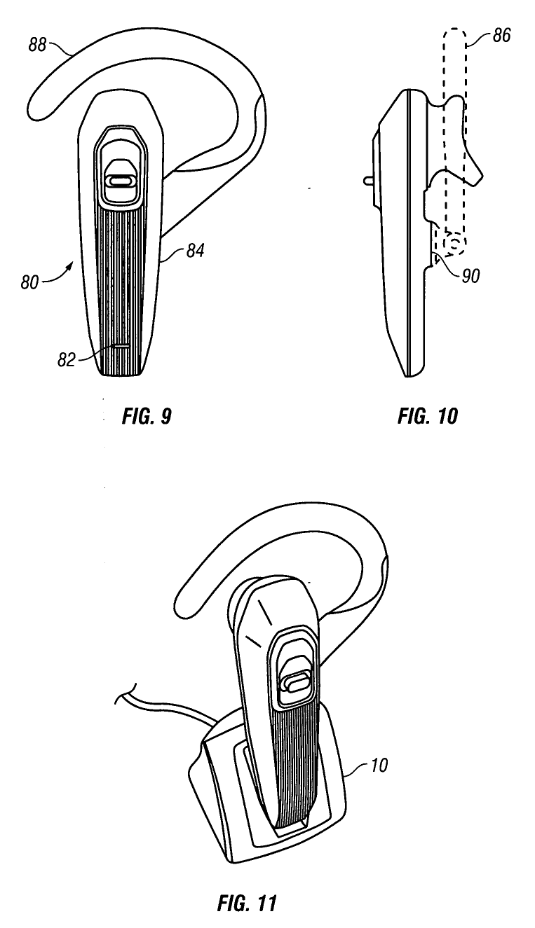

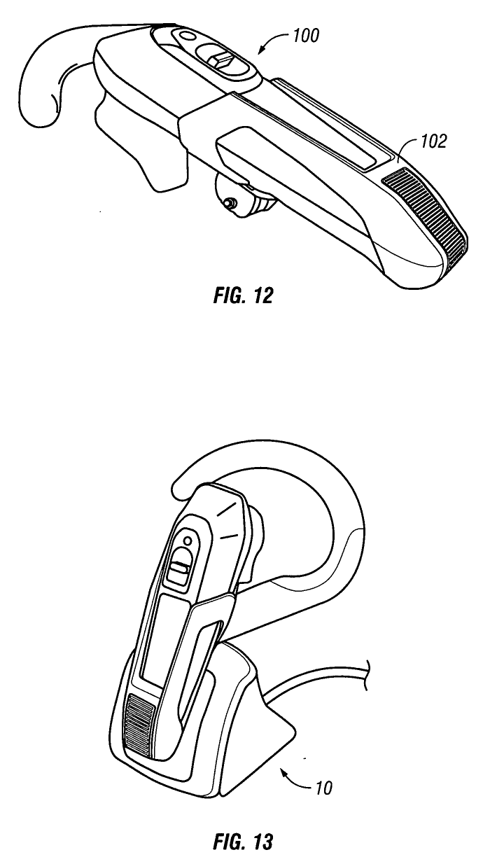

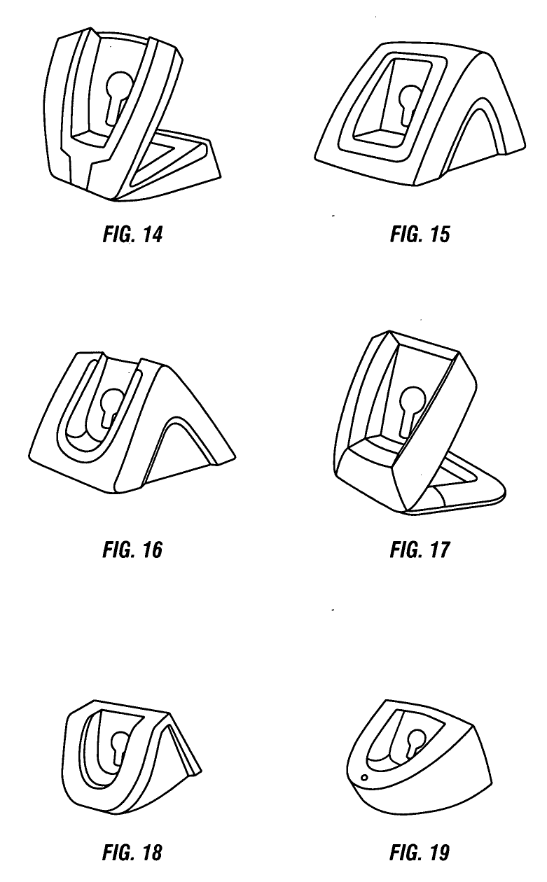

Turning now to FIGS. 9-11, a headset 80 is shown. The headset 80 includes a microphone 82 a body 84 an ear bud 86 an ear hanger 88 and a charging jack 90. (For clarity, the ear hanger 88 is not shown in FIG. 10.) In operation the user removes the headset from his/her ear and presses the lower part of the headset into the V-shaped indentation 74 of cradle 20, and although not shown, it should be understood that the plug 22 is engaged with the charging jack 90. Thus the headset 80 is conveniently stored while it is charging. To use the charged headset 80, the user simply pulls the headset 80 from the support 10.

Turning now to FIGS. 12 and 13 an alternative headset 100 is illustrated. The headset 100 is similar to the headset 80, and the headset 100 includes a windscreen 102. The windscreen is a conventional device which can be clipped onto the lower part of the headset 100 to reduce noise caused by wind blowing on the microphone of the headset 100. The illustrated headset 100 is of the same dimensions as the headset 80, and therefore the headset 100 with the windscreen 102 has dimensions which are larger than those of the headset 80. However, it should be understood that the same support 10 can be used to store and recharge both headset 80 and headset 100 with windscreen 102. This is because the cradle 20 is sized and shaped appropriately and because of the resilient nature of the cradle 20.

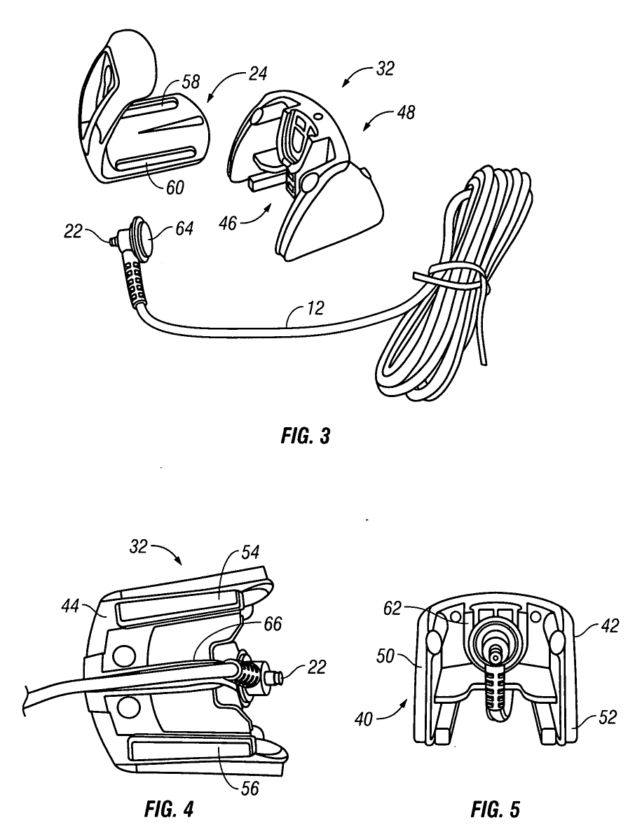

Another feature of the present system can be appreciated from FIGS. 3-5. It can be understood that a user can disassemble the device as shown in FIG. 3 and simply plug the plug 22 into the charging jack 90 of the headphone 80 while the headphone is e.g. lying on a desk. Alternatively, the user can easily assemble the device as shown in first in FIG. 2 and then FIG. 1 and use the device to support and recharge the headphone as shown in FIG. 11.

Turning now to FIGS. 14-19, alternative embodiments are shown. In these different embodiments it can be understood that the shape of the cradle is different to accommodate different shapes of headphones, and the shape of the device is different depending upon aesthetic considerations.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A system for recharging a headset comprising:
a base;
a cradle connected to said base; and
an electrical plug coupled to said base,
wherein said cradle is formed of resilient material which is deformable to accommodate headsets of different dimensions.

2. A system according to claim 1 wherein said cradle comprises an indentation formed to cooperate with the lower section of the headset.

3. A system according to claim 1 wherein said base further comprises a headset support section.

4. A system according to claim 3 wherein said cradle is coupled to said headset support section of said base.

5. A system according to claim 1 wherein said headset support section comprises a face which includes a cut out section.

6. A system according to claim 5 wherein said a cradle is coupled to said cut out section of said headset support section of said base.

7. A system for recharging a headset comprising:
a base comprising a flat section constructed and arranged to sit on a horizontal, flat surface and further comprising a headset support section;
a cradle comprising resilient material coupled to said headset support section of said base;
a charging system support member constructed and adapted to be coupled to said base; and
an electrical charging system connected to said charging system support member.

8. A system according to claim 7 wherein said electrical charging system comprises a plug, and said charging system support member is constructed and adapted so that when said electrical charging system is coupled to said charging system support member and the headset is located in said cradle, a charging jack of the headset engages said plug.

9. A kit for recharging a headset comprising:
an electrical charging system comprising a transformer coupled to a first end of an electrical cable and a plug coupled to a second end of said electrical cable;
a base comprising a flat section constructed and arranged to sit on a horizontal, flat surface and further comprising a headset support section; and
a charging system support member coupled to said base,
wherein said a charging system support member is constructed and adapted so that said plug and a section of said electrical cable can be temporarily coupled to said charging system support member and said plug and a section of said electrical cable can be decoupled from said charging system support member so that said electrical charging system can be used to charge the headset when the headset is located in said headset support section and said electrical charging system can be used to charge the headset when the headset is not located in said headset support section.

10. A kit according to claim 9 wherein said headset support section further comprises a cradle to accommodate the headset.

11. A kit according to claim 9 wherein said charging system support member is constructed and adapted so that when said plug is coupled to said base and a headset is located in said cradle, said plug is located to engage a charging jack in the headset.

12. A kit according to claim 9 wherein said a charging system support member comprises a back, a front, a bottom, a first side, and a second side, and said front comprises a plug engagement member and said bottom comprises an electrical cable engagement member.

13. A kit according to claim 12 wherein said plug engagement member and said electrical cable engagement member are resilient so that a user can easily couple and decouple said plug and said electrical cable to and from said engagement members.

14. A headset system comprising:
a first headset having a microphone and a windscreen located adjacent to the microphone;
a second headset having a microphone and no windscreen so that the dimensions of the second headset are less than the dimensions of the first headset with the windscreen;
a recharging system base;
a cradle connected to said recharging system base; and
an electrical plug connected to said recharging system base,
wherein said cradle is formed of resilient material which is deformable to accommodate either the first headset or the second headset.

15. A method of recharging two headsets wherein a first headset has a microphone and a windscreen located adjacent to the microphone; a second headset has a microphone and no windscreen so that the dimensions of the second headset are less than the dimensions of the first headset with the windscreen, the method comprising:
locating the first headset in a recharging device;
removing the first headset from the recharging device; and
thereafter locating the second headset in the same recharging device.
